(19) United States
(12) Patent Application Publication
(10) Pub. No.: US 2026/0254883 A1
(43) Pub. Date: Aug. 27, 2026

(54) INTERFACE SCHEDULER

(71) Applicant: Micron Technology, Inc., Boise, ID (US)

(72) Inventors: Leon Zlotnik, Camino, CA (US); Leonid Minz, Beer Sheva (IL)

(21) Appl. No.: 19/544,817

(22) Filed: Feb. 19, 2026

Related U.S. Application Data
(60) Provisional application No. 63/764,064, filed on Feb. 27, 2025.

(51) Int. Cl. H04L 67/62

(52) U.S. Cl. CPC H04L 67/62

(57) ABSTRACT

A method for predictive scheduling of transactions in a multi-channel communication interface involves a scheduler receiving a speculative transaction complete indication from a channel manager before the actual completion of a transaction. The scheduler determines the next transaction to pre-stage based on predefined criteria and sends it to the channel manager. Upon receiving an actual transaction complete message, the scheduler assesses system conditions, including power consumption limits and the number of concurrent transactions, to decide whether to release the next transaction. This method reduces transaction latency and enhances overall system efficiency.

### PRIORITY APPLICATION

This application claims the benefit of priority to U.S. Provisional Application Ser. No. 63/764,064, filed Feb. 27, 2025, which is incorporated herein by reference in its entirety.

### TECHNICAL FIELD

Embodiments pertain to data transfer and communication systems. Some embodiments relate to predictive scheduling techniques for managing transactions in multi-channel interfaces.

### BACKGROUND

As technology advances, the demand for higher data transfer rates and increased processing power continues to grow. These demands have led to the development of sophisticated communication buses that facilitate data transfer between various components such as processors, memory devices, and peripheral units. These communication buses enable multiple channels to operate concurrently, allowing for efficient data throughput and system performance. For example, memory systems, may utilize an Open NAND Flash Interface (ONFI) bus to connect controllers to groups of NAND dies, enabling high-speed data transfers for applications ranging from consumer electronics to enterprise storage solutions. The independent operation of ONFI channels allows for simultaneous data transfers, which is beneficial for maximizing data throughput and overall system efficiency.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a timing diagram showing requests for transactions and transaction execution on respective channels of a communication interface, according to some examples of the present disclosure.

FIG. 2 illustrates a timing diagram showing requests for transactions and transaction execution on respective channels of a communication interface, according to some examples of the present disclosure.

FIG. 3 shows a logical diagram of a memory device, according to some examples of the present disclosure.

FIG. 4 illustrates a computing system with three components connected to a controller, according to some examples of the present disclosure.

FIG. 5 illustrates an example computing environment including a memory system, according to some examples of the present disclosure.

FIG. 6 shows a flowchart of a method of a scheduler performing a predictive transaction scheduling, according to some examples of the present disclosure.

FIG. 7 shows a flowchart of a method of a channel manager pre-staging a transaction, according to some examples of the present disclosure.

FIG. 8 illustrates a block diagram of an example machine upon which any one or more of the techniques discussed herein may be performed, according to some examples of the present disclosure.

### DETAILED DESCRIPTION

The use of multiple communication channels of a communication interface in a device presents challenges in managing the transactions executed across these channels. For example, when a channel completes a transaction, it takes some time to initiate a new transaction on that channel. In some memory devices, there can be a gap of up to 2 microseconds between the completion of an ONFI transfer and the initiation of the next transfer. This delay results in suboptimal utilization of the communication bus and can cause performance bottlenecks. Additionally, the interface controllers may struggle to distinguish between multiple transfers waiting in the same channel versus those divided among multiple channels, and they cannot precisely control peak power consumption and voltage control due to their lack of synchronization with the interface. These limitations hinder the system's ability to manage transient current among multiple channels effectively, leading to reduced throughput, increased transient power noise, and inefficient arbitration between different types of operations such as read, write, and erase.

Disclosed in some examples are methods, systems, devices, and machine-readable mediums that decrease transaction latency on a system interface by utilizing predictive scheduling. A channel manager, which manages a channel of an interface may utilize historical transaction data to predict the completion time of pending transactions. A prespecified time prior to the predicted completion, the channel manager may signal to the interface manager that the transaction is finished. A scheduler may then send a next transaction to the channel manager. The channel manager queues the transaction. When the predicted completion time expires, the channel manager checks the status of the transaction. If it is not complete, then the channel manager continues to poll at specified times to determine whether the transaction is complete. Once the transaction is complete, then the channel manager reports to the scheduler. The scheduler, which tracks all the pending transactions, releases, at the appropriate time, the queued transaction using a release message. By predictive scheduling of transactions, the system may reduce transaction latency across the communication interface. In examples where the interface is ONFI and the device is a memory device, the latency may be decreased by approximately 2 microseconds.

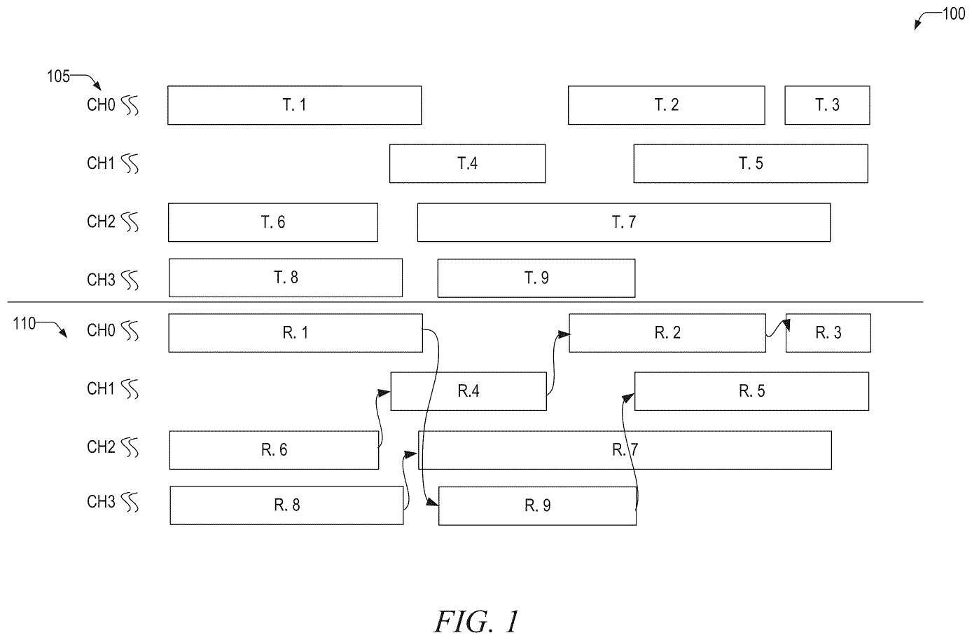

FIG. 1 illustrates a timing diagram 100 showing requests for transactions and transaction execution on respective channels of a communication interface according to some examples of the present disclosure. The timing diagram 100 is a timing diagram that illustrates a sequence of transactions 105 and requests 110. In the example of FIG. 1, only three channels are permitted to be active at a time due to power constraints. Requests are requests from a scheduler to a manager of the communication channel to begin a corresponding transaction. Transactions are the actual execution of those transactions between the channel and the component across the communication interface. In examples in which the system is a memory system, the components across the communication interface are memory dies. Requests correspond to transactions with a same number (e.g., R2 corresponds to T2).

At the beginning of the timing diagram, all three channels are engaged in transactions (transactions T1, T6, and T8). Once transaction 6 finishes, there is a delay before request R4 and the subsequent transaction T4 is issued. This delay is illustrated by the arrow between R6 and R4. Similarly, there is a delay between when T8 completes and when R7 is issued-which is also signified by the arrow from R8 to R7. Similarly, the delay from when T4 completes and when request R2 is sent to perform T2 and the delay when T9 completes and when R5 is issued; and when T2 completes and R3 is issued are also represented by arrows. As can be appreciated the delay in issuing new requests when previous transactions complete increases transaction latency and reduces the efficiency of the communication interface.

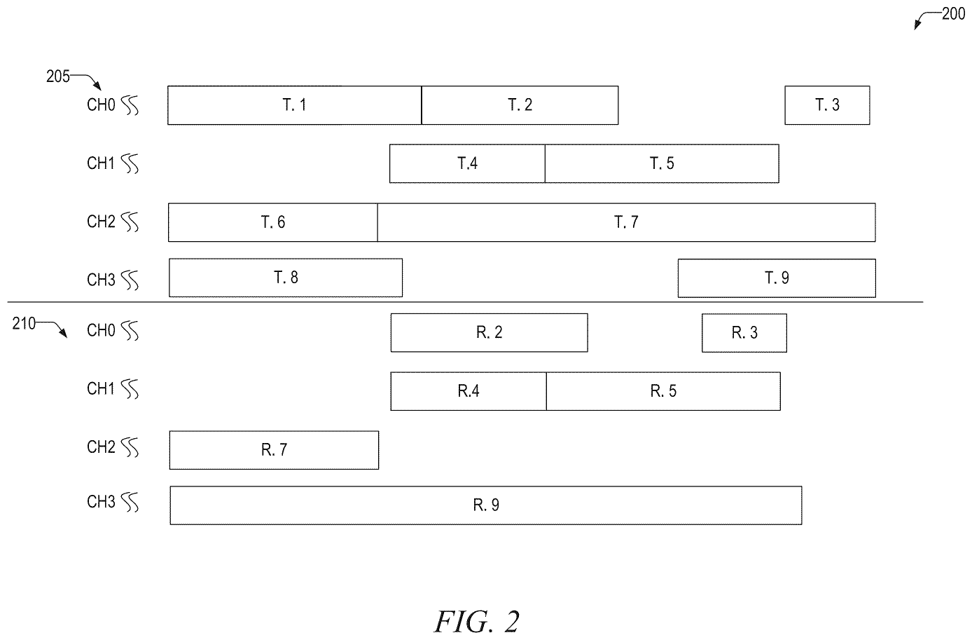

FIG. 2 illustrates a timing diagram 200 showing requests for transactions and transaction execution on respective channels of a communication interface according to some examples of the present disclosure. The timing diagram 200 is a timing diagram that illustrates a sequence of transactions 205 and requests 210. In the example of FIG. 1, only three channels are permitted to be active at a time due to power constraints. Requests are requests from a scheduler of the controller to a manager of the communications channel to begin a transaction. Transactions are the actual execution of those transactions between the channel and the component across the communication interface. In examples in which the system is a memory system, the components across the communication interface are memory dies. Requests correspond to transactions with a same number (e.g., R2 corresponds to T2).

As can be appreciated, the gaps between when a transaction ends and when a new transaction begins have been eliminated. For example, when T1 ends the request R2 has already been sent and staged at the channel manager for channel 0. Channel 0 is thereby ready to begin executing transaction T2 (corresponding to transaction R2). Requests correspond to transactions with a same number (e.g., R2 corresponds to T2). In some examples, the channel manager sends a speculative complete to the scheduler who then pre-stages the next transaction at the channel manager. Once the transaction is complete the channel manager informs the scheduler and the scheduler releases the staged transaction if the execution of the transaction would not put the system over the power limit. Because the transaction is staged, only a small amount of messaging is used to release the transaction. This contrasts with pre-existing systems which take time to load a new request after the pending transaction is completed.

In some examples, the scheduler may pre-stage two or more transactions. For example, if there is a maximum simultaneous transaction count of three, and there are three pending transactions currently, but two channel managers have indicated speculative completions, the scheduler may stage two waiting transactions. The first channel manager to indicate that that its transaction is actually complete will have its pre-staged transaction released. This keeps the communication interface occupied. In some examples, the scheduler may pre-stage a same transaction on both channels-that is, a high priority transaction may be pre-staged on both channels but may only be released on a first channel where the channel manager reports its transaction is complete. The other pre-staged transaction may be cancelled. This allows the high priority transaction to be executed as fast as possible.

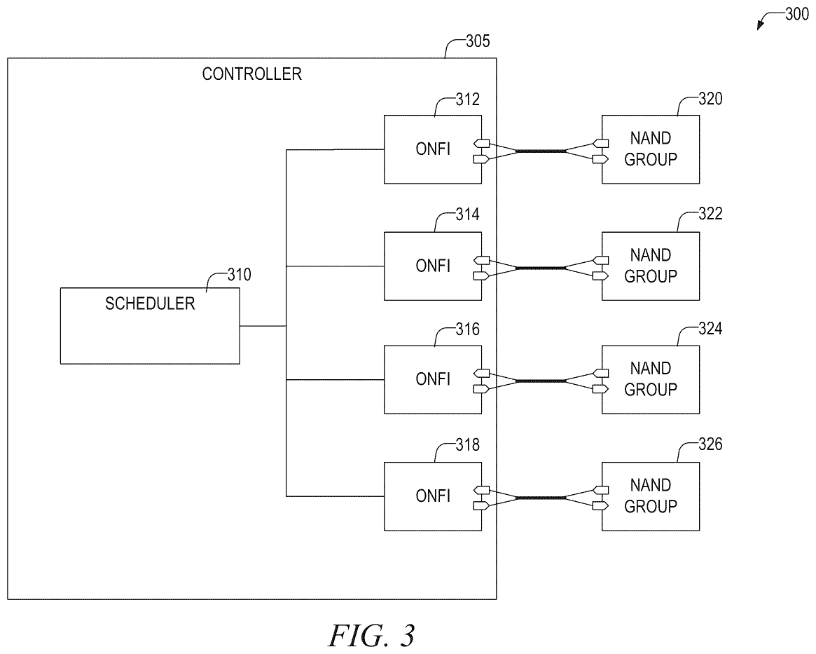

FIG. 3 shows a logical diagram of a memory device 300 according to some examples of the present disclosure. The memory device includes a controller 305 which communicates across an Open NAND Flash Interface (ONFI) to multiple NAND die groups 320-326. The controller 305 includes a scheduler 310, which is responsible for managing the communication and control of multiple ONFI channel managers 312-318. The scheduler 110 interfaces with four ONFI channel managers: ONFI Channel manager 312, ONFI Channel manager 314, ONFI Channel manager 316, and ONFI Channel manager 318.

Each ONFI channel manager may manage one or more ONFI channels and may be connected to a corresponding one or more NAND dies. Specifically, in FIG. 3, ONFI Channel manager 312 controls a channel connected to a NAND Die group 320, ONFI Channel manager 314 controls a channel that is connected to NAND Die group 322, ONFI Channel manager 316 controls a channel that is connected to NAND Die group 324, and ONFI Channel manager 318 controls a channel that is connected to NAND Die group 326. NAND die groups include one or more NAND dies. These connections facilitate the transfer of data and control signals between the scheduler 310 and the NAND dies.

The scheduler 310 coordinates the operations of the ONFI channels and the NAND dies, ensuring that data transfers and power management are performed efficiently. The ONFI channel managers 312, 314, 316, and 318 handle the communication across their respective ONFI channels with the respective NAND dies within the NAND die groups 320, 322, 324, and 326, enabling the memory device 300 to perform read and write operations effectively. The scheduler 310 is responsible for scheduling requests on the ONFI channels. The ONFI channel managers then carry out the transactions.

The ONFI channel managers 312-318 may execute one or more transactions across their channels directed toward their NAND groups. Once a transaction is started, it's estimated completion time may be calculated by the ONFI channel manager. This may be based upon a calculation made by the channel managers according to a formula that may depend on the memory access being conducted and the size of that access. In other examples this may be made based upon a lookup table. The ONFI channel managers may set a timer or interrupt for a time just prior to the expected completion time of the transaction. Once the timer expires or interrupt fires, the channel managers may signal to the scheduler 310 a pre-emptive completion message. This signals the scheduler 310 that the channel is about to become free. Additionally, at the expected completion time, the ONFI channel managers may poll the NAND dies to determine whether the transaction is complete. If it is complete the ONFI channel managers may send an actual completion to the scheduler 310. Prior to this, the scheduler 310 may send a stage transaction request to the ONFI channel managers which store the request.

The scheduler 310 receives speculative completion requests from the ONFI channel managers 312-318 and determines whether to pre-stage a request from a list of available requests by sending it to one of the ONFI channel managers 312-318. In some examples, the pre-staged request may be sent to the ONFI channel manager that indicated the speculative completion. In other examples, the pre-staged request may be sent to an ONFI channel manager that is currently idle. Either way, the scheduler 310 may wait until the number of active channels is less than the maximum amount of active channels given the systems power control rules at the time. This means waiting for the actual completion from the ONFI channel manager. Once the transaction complete message is sent by the channel manager and received by the scheduler 310, the scheduler 310 determines which staged transaction to release. As noted earlier, the scheduler 310 may pre-stage several transactions. The decision of whether and which transaction to release may be based upon request priority (e.g., with more urgent requests released first), the type of operation (e.g., read, write, or erase), the current power consumption, the expected duration of the transaction, the inter-channel priority arbitration, and the like. Additionally, the scheduler may consider the historical performance data of the channels, the current load on each channel, and any specific quality of service (QoS) requirements.

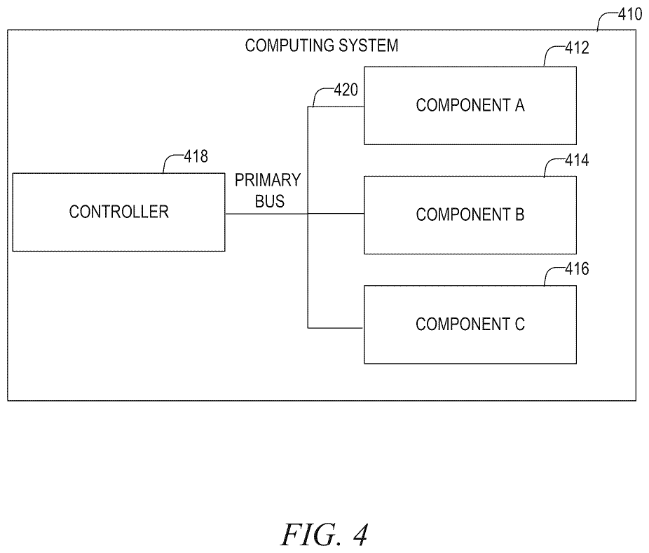

While the present disclosure has described the inventive techniques disclosed herein in the context of memory systems, a person of ordinary skill in the art will appreciate that these inventive techniques may be utilized with other systems as well. FIG. 4 illustrates a computing system 410 with three components: component A 412, component B 414, and component C 416. The three components are connected to a controller 418. The controller configures, receives status information from, and/or manages the components.

The primary bus 420 is a communication interface used primarily by the controller 418 to communicate data and operations with the components. For example, if the components are memory devices, the primary bus 420 may be used to communicate data stored in the memory devices.

Controller, component A 412, component B 414, and/or component C 416 may be software components or hardware components (e.g., logic circuits such as an Application Specific Integrated Circuit (ASIC)). In some examples, the controller, component A 412, component B 414, and/or component C 416 may be on a same device. In other examples, one or more of the components and the controller 418 may be, or be located on, different devices. In some examples, the communication interface (e.g., primary bus 420) may be a local bus such as Peripheral Component Interconnect (PCI), Universal Serial Bus, memory bus, token ring bus, ethernet bus, and the like. In other examples, the communication interface may be remote bus such as those facilitating communication between devices. For example, a CXL bus. The controller 418 may include a scheduler, such as scheduler 310 which receives speculative complete messages from managers of the channels of the primary bus 420 and then stages a next transaction as described from FIG. 3 to decrease latency of the primary bus 420.

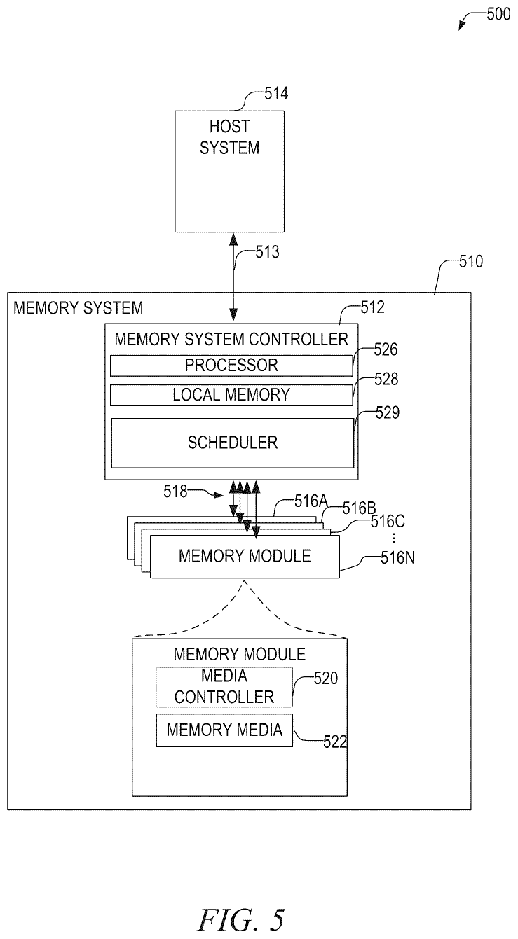

FIG. 5 illustrates an example computing environment 500 including a memory system 510, in accordance with some examples of the present disclosure. In some examples, the memory system 510 can be volatile storage such as Random Access Memory (RAM), stage memory, dynamic RAM (DRAM), synchronous DRAM (SDRAM), double data rate SDRAM (DDR), static RAM (SRAM), Graphics DDR (GDDR), or the like. In some examples, the memory system 510 can be non-volatile storage such as a Not-AND (NAND) flash, NOR flash, magnetic storage (e.g., a hard-disk drive), tape storage, or the like. In some examples, the memory system 510 can include both volatile and non-volatile storage, by utilizing, for example, memory modules 516A-N containing different types of memory media 522 or by utilizing one or more single memory modules that include both volatile and non-volatile memory media 522. The memory system 510 may be an error-correcting memory system in that at least some of the memory media 522 includes error correcting memory.

In an example, the memory system 510 can be a discrete memory and/or storage device component of a host system. In other examples, the memory system 510 can be a portion of an integrated circuit (e.g., system on a chip (SOC), etc.), stacked or otherwise included with one or more other components of a host system. In some examples, the memory system 510 may be part of a distributed memory system with multiple memory systems 510 and multiple host systems that may each include one or more processors. For example, a distributed memory system may operate according to a Compute Express Link (CXL) framework, such as a CXL. mem framework. The memory system may also have compute capabilities to support compute-near-memory functionalities-e.g., by using the processor 526 of memory system controller 512, media controller 520, or some other processor that is not shown.

As noted, the host 514, as well as memory system 510 can be integrated into a single host computing system. The host system can be in the form of a desktop computer, laptop computer, network server, mobile device, or such computing device that includes a memory and a processing device. The host system and/or the memory system 510 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the host 514 and to the memory system 510 so that the host system can read data from or write data to the memory system 510. As used herein, “coupled to” generally refers to a connection between components, which can be an indirect communicative connection or direct communicative connection (e.g., without intervening components), whether wired or wireless, including connections such as, electrical, optical, magnetic, and the like.

The memory system 510 is configured with a memory system controller 512 that interfaces with the host 514. The host 514 may include a hardware processor, which may be a multi-core hardware processor, and communicates with the memory system controller 512 via a memory controller interface 513. Through this interface, the host 514 can issue commands to the memory system controller 512, such as a request to store data, which is accompanied by the data itself and potentially the target memory address for storage. In response, the memory system controller 512 can acknowledge the command and execute the data storage operation, providing confirmation back to the host 514 through the memory controller interface 513. Similarly, the host 514 can send a command to retrieve data, specifying the memory address from which to load the data. Upon receiving such a command, the memory system controller 512 retrieves the requested data and delivers it to the host 514 through the memory controller interface 513.

In certain embodiments, the host 514 and the memory system controller 512 are integrated onto a single die or different dies, but within a unified package. For example, in systems based on the x86 architecture, the memory system controller 512 is typically on the same die as the processor cores of host 514, thereby streamlining the memory access operations. Alternatively, there are configurations where the memory system controller 512 is situated on a distinct die, separate from that of the host 514 but within a same CPU package, allowing for modular design and potential customization of the memory system. In yet other examples, the memory system controller 512 may not be on the same die or package as the host 514.

The host 514 may communicate with the memory system controller 512 through a memory controller interface 513 and the memory system controller 512 may communicate with one or more memory modules 516A-516N upon which the physical memory is located through the memory module interface 518. In examples in which the memory system controller 512 is not on the same die or package as the host 514, the memory controller interface 513 may be the system bus, front-side bus, or other interface and the memory module interface 518 may be an internal bus of the memory system 510, such as internal pins or traces or some other interface such as an ONFI bus. In other examples, where the memory system controller 512 is on a same die or package as the host 514, the memory controller interface 513 may be one or more traces, pins, or some other interface and the memory module interface 518 may be a system bus.

The memory controller interface 513 and/or the memory module interface 518 may, depending on the design of the system, operate as one or more traces or pins, a Peripheral Component Interconnect-Express (PCIe) interface, a UFS interface, a serial advanced technology attachment (SATA) interface, a universal serial bus (USB) interface, an ONFI interface, a Fibre Channel interface, Serial Attached SCSI (SAS) interface, memory fabric, an eMMC interface, or the like.

The memory modules, designated as 516A through 516N, are capable of incorporating a diverse array of memory media 522, which may be either volatile or non-volatile in nature. The memory media 522 is comprised of elements such as memory cells, magnetic sectors, or equivalent data storage units. These memory modules can manifest in various configurations, including but not limited to Single Inline Memory Modules (SIMMs), Dual Inline Memory Modules (DIMMs), Solid State Drives (SSDs), embedded MultiMediaCards (eMMCs), Hard Disk Drives (HDDs), tape drives, among others. The memory media 522 within modules 516A-516N may encompass Random Access Memory (RAM), Static RAM (SRAM), Dynamic RAM (DRAM), Synchronous DRAM (SDRAM), NAND flash memory, magnetic media, phase-change memory (PCM), magneto-resistive random access memory (MRAM), NOR flash memory, electrically erasable programmable read-only memory (EEPROM), cross-point memory, and similar technologies. For instances where the memory media 522 consists of NAND-type memory, the configuration may involve a range of cell architectures, from single-level cells (SLCs) to multi-level cells (MLCs). MLCs may include triple-level cells (TLCs), quad-level cells (QLCs), and the like.

In some examples, the data storage units of the memory media 522 (such as memory cells) may be organized into one or more logical structures. For volatile storage, one example of a logical organization groups memory cells by ranks, banks, rows, and columns. For non-volatile storage, one example logical organization includes grouping cells into planes, sub-blocks, blocks, and/or pages. Other logical organizations may include sectors, tracks, cylinders, clusters, and so on.

In some examples, one or more of the memory modules 516A-516N may include a media controller 520 that may handle tasks such as accessing data from the memory media, writing data to the memory media, refreshing memory cells and communications over the memory module interface with the memory system controller 512. For example, the media controller 520 can parse a command and determine the affected memory cells from the memory media 522 and can read and/or write a desired value to those memory cells. Media controller 520 can be responsible for refreshing or otherwise maintaining the data stored in the memory media 522. In some examples, the media controller 520 may handle one or more of the functions traditionally associated with the memory system controller 512. In some examples, the memory modules 516A-N do not include a media controller 520.

The media controller 520 can include hardware such as one or more integrated circuits and/or discrete components, a buffer memory, or a combination thereof. The media controller 520 can be a microcontroller, special purpose logic circuitry (e.g., a field programmable gate array (FPGA), an application specific integrated circuit (ASIC), etc.), or other suitable processor(s). The media controller 520 can include a processor (processing device) configured to execute instructions stored in a local memory. Media controller 520 can also include address circuitry, row decoders, I/O circuitry write circuitry, column decoders, sensing circuitry, and other latches for decoding addresses, writing to, and reading from the memory media 522.

The local memory of the media controller 520 can include embedded memory configured to store instructions for performing various processes, operations, logic flows, and routines that control the memory media 522, including handling communications between the memory module 516A-516N and the memory system controller 512. In some embodiments, the local memory of the media controller 520 can include memory registers storing, e.g., memory pointers, fetched data, etc. The local memory can also include read-only memory (ROM) for storing micro-code.

The memory system controller 512 (controller) can include a processor 526 configured to execute instructions stored in a local memory 528. The processor 526 can be a microcontroller, special purpose logic circuitry (e.g., a field programmable gate array (FPGA), an application specific integrated circuit (controller), etc.), general purpose processor configured by software (e.g., firmware), or other suitable processor. In the illustrated example, the local memory 528 may store instructions for performing various processes, operations, logic flows, and routines that control operation of the memory system 510, including handling communications between the memory system 510 and the host 514 and communications between the memory system controller 512 and the memory modules 516A-516N. In some embodiments, the local memory 528 of the memory system controller 512 can include memory registers storing, e.g., memory pointers, fetched data, etc. The local memory can also include read-only memory (ROM) for storing micro-code.

Local memory 528 may also include various management tables such as translation tables translating logical addresses used by the host 514 into physical memory addresses that define a physical location of the memory cells. In other examples, the management tables can instead or additionally include information regarding block age, block erase count, error history, or one or more error counts (e.g., a write operation error count, a read bit error count, a read operation error count, an erase error count, etc.) for one or more blocks of memory cells coupled to the memory system controller 512.

As noted, the memory system controller 512 can receive commands or operations (memory access commands) from the host 514 (or other component of a host) and can convert the commands or operations into instructions or appropriate commands to achieve the desired access to the memory modules 516A to 516N. The memory system controller 512 can be responsible for other operations such as wear leveling operations (e.g., garbage collection operations, reclamation), error detection and error-correcting code (ECC) operations, refresh operations, encryption operations, caching operations, block retirement, and address translations between a logical block address and a physical block address that are associated with the memory modules 516A to 516N. The memory system controller 512 can further include interface circuitry to communicate with the processor via the memory controller interface 513. The interface circuitry can convert the commands received from the host 514 into command instructions to access the memory modules 516A to 516N over the memory module interface 518 as well as convert responses associated with the memory modules 516A to 516N into information for the host 514 or other component of the host system. The memory system controller 512 may include scheduler 529 which may be an example of scheduler 310, which may stage transactions to decrease transaction latency as described herein.

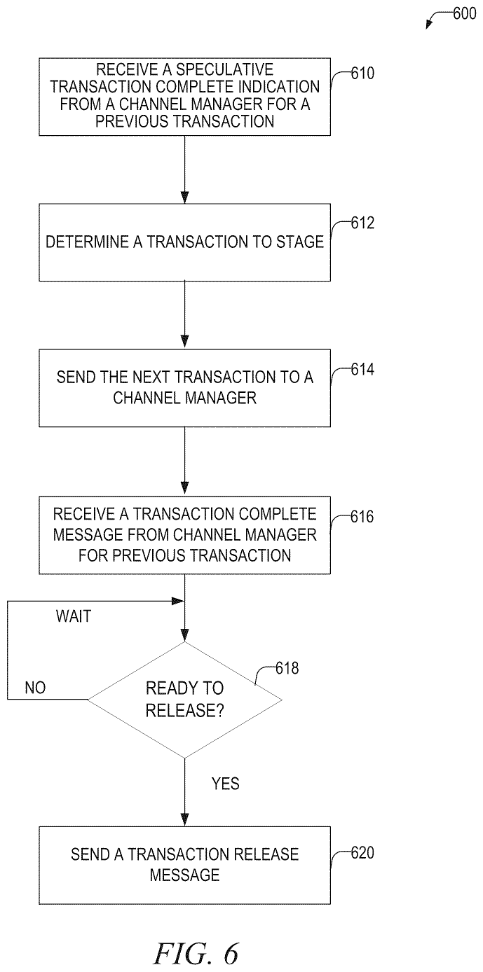

FIG. 6 shows a flowchart of a method 600 of a scheduler performing a predictive transaction scheduling according to some examples of the present disclosure. The method 600 begins with the scheduler receiving a speculative transaction complete indication from a channel manager for a previous transaction at operation 610. This speculative indication is sent by the channel manager before the actual completion of the transaction, based on a predicted completion time.

Next, at operation 612, the scheduler determines a transaction from a list of waiting transactions to pre-stage. This step involves selecting the subsequent transaction, based on predefined criteria such as priority, type of operation, and current system load. At operation 614, the scheduler then sends the transaction determined at operation 612 to a channel manager. The channel manager may be the same channel manager (for a same or different channel) from whom the speculative transaction complete indication was received. In other examples, the channel manager that the staged transaction is sent to may be a different channel manager. This pre-staging of the next transaction ensures that the system is ready to initiate the new transaction as soon as the previous one completes to reduce latency.

Following this, at operation 616, the scheduler receives a transaction complete message from the channel manager for the previous transaction. This message confirms the actual completion of the previous transaction, allowing the scheduler to proceed with the next steps. At operation 618, the scheduler then checks if the system is ready to release the next transaction. This decision is based on factors such as the number of concurrent transactions, power consumption limits, and other system constraints. If the system is not ready, the scheduler waits until the conditions are met. Once the system is ready, at operation 620, the scheduler sends a transaction release message. This message authorizes the channel manager to start the next transaction, thereby minimizing latency and improving overall system efficiency.

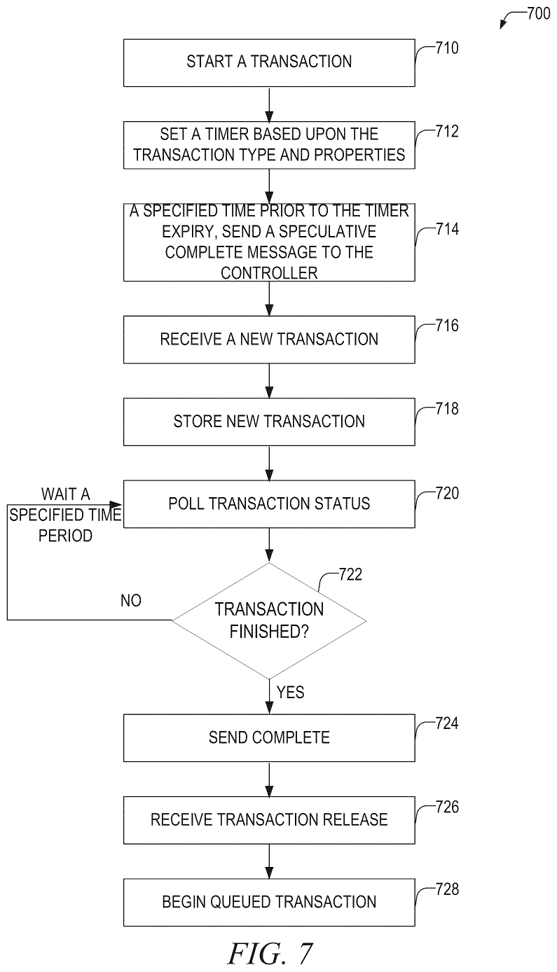

FIG. 7 shows a flowchart of a method 700 of a channel manager pre-staging a transaction according to some examples of the present disclosure. The process begins with starting a transaction at operation 710. The channel manager initiates a transaction based on the current system requirements and the type of operation to be performed. Next, at operation 712, the channel manager sets a timer based upon the transaction type and properties. This timer is configured to estimate the completion time of the transaction, taking into account the specific characteristics and requirements of the transaction. At operation 714, a specified time prior to the timer expiry, the channel manager sends a speculative complete message to the controller. This speculative message indicates to the controller that the transaction is nearing completion, allowing the controller to prepare for the next transaction.

The channel manager then receives a new transaction at operation 716. This new transaction is queued and stored for future execution. At operation 718, the new transaction is stored in the channel manager's queue, ready to be executed once the current transaction completes. At operation 720, the channel manager polls the transaction status to determine if the current transaction has finished. This polling may occur at regular intervals to check the completion status of the transaction.

A decision point at operation 722 checks whether the transaction is finished. If the transaction is not finished, the channel manager waits a specified time period before polling the transaction status again. Once the transaction is finished, at operation 724, the channel manager sends a complete message to the controller, indicating that the transaction has been successfully completed. The controller then receives the transaction release at operation 726, authorizing the channel manager to proceed with the next transaction in the queue. At operation 728, the channel manager begins the queued transaction, initiating the next transaction that was previously stored and queued.

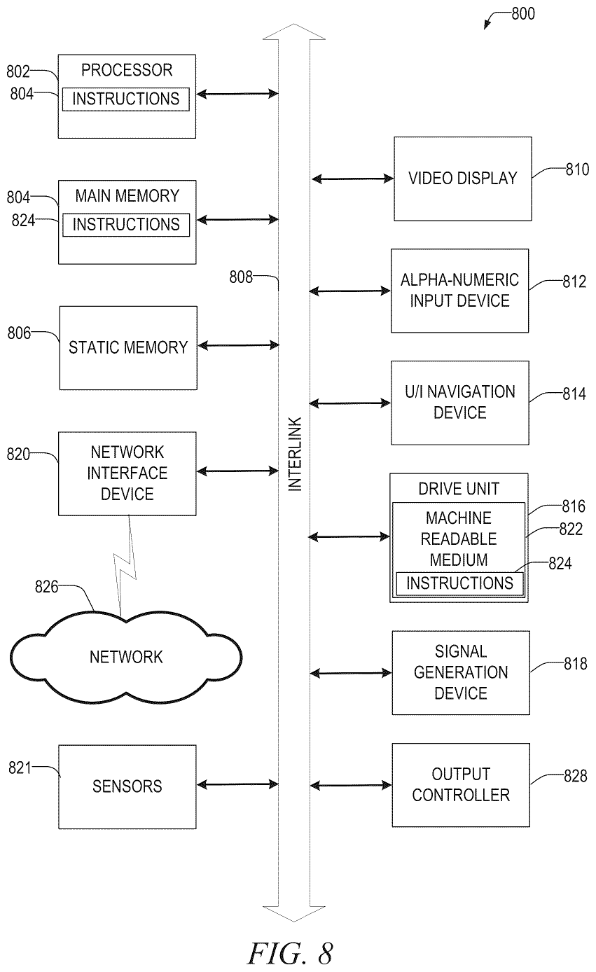

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be in the form of a memory device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 800 may implement the timing diagrams of FIGS. 1 and 2; the system of FIGS. 3 and 4; the memory system of FIG. 5; and the method of FIG. 6.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 800 may include one or more hardware processors, such as processor 802. Processor 802 may be a central processing unit (CPU), a graphics processing unit (GPU), a hardware processor core, or any combination thereof. Machine 800 may include a main memory 804 and a static memory 806, some or all of which may communicate with each other via an interlink (e.g., bus) 808. Examples of main memory 804 may include Synchronous Dynamic Random-Access Memory (SDRAM), such as Double Data Rate memory, such as DDR4 or DDR5. Interlink 808 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated stages and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### Other Notes and Examples

Example 1 is a method for predictive scheduling of transactions in a multi-channel communication interface, the method comprising: at a system controller, using one or more hardware processors: receiving, by a scheduler, a speculative transaction complete indication from a channel manager for a first transaction, the speculative transaction complete indication being sent prior to an actual completion of the first transaction, the channel manager managing a channel of the multi-channel communication interface; responsive to receiving the speculative transaction complete indication: determining, by the scheduler, a next transaction to pre-stage from a list of pending transactions based on predefined criteria; and sending, by the scheduler, the next transaction to the channel manager for pre-staging; subsequent to receiving the speculative transaction complete indication, receiving, by the scheduler, an actual transaction complete message from the channel manager indicating the actual completion of the first transaction; and responsive to receiving the actual transaction complete message: determining, by the scheduler, whether system conditions are met to release the next transaction, the system conditions including power consumption limits; and sending, by the scheduler, a transaction release message to the channel manager to authorize execution of the next transaction.

In Example 2, the subject matter of Example 1 includes, calculating, by the channel manager, a predicted completion time of the first transaction based on historical transaction data.

In Example 3, the subject matter of Example 2 includes, sending, by the channel manager, the speculative transaction complete indication to the scheduler a specified time prior to the predicted completion time.

In Example 4, the subject matter of Example 3 includes, by the channel manager, polling a status of the first transaction at specified intervals after the predicted completion time until the first transaction is complete.

In Example 5, the subject matter of Examples 1-4 includes, wherein determining the next transaction to pre-stage comprises prioritizing, by the scheduler, the next transaction based on a type of operation, including read, write, or erase operations.

In Example 6, the subject matter of Examples 1-5 includes, wherein the system conditions comprise a limit on a number of active channels.

In Example 7, the subject matter of Examples 1-6 includes, determining, by the scheduler, whether the system conditions are met to release the next transaction based on factors including the number of concurrent transactions, power consumption limits, and current system load.

Example 8 is a non-transitory machine-readable medium, storing instructions for predictive scheduling of transactions in a multi-channel communication interface, the instructions, which when executed, cause the machine to perform operations comprising: receiving, by a scheduler, a speculative transaction complete indication from a channel manager for a first transaction, the speculative transaction complete indication being sent prior to an actual completion of the first transaction, the channel manager managing a channel of the multi-channel communication interface; responsive to receiving the speculative transaction complete indication: determining, by the scheduler, a next transaction to pre-stage from a list of pending transactions based on predefined criteria; and sending, by the scheduler, the next transaction to the channel manager for pre-staging; subsequent to receiving the speculative transaction complete indication, receiving, by the scheduler, an actual transaction complete message from the channel manager indicating the actual completion of the first transaction; and responsive to receiving the actual transaction complete message: determining, by the scheduler, whether system conditions are met to release the next transaction, the system conditions including power consumption limits; and sending, by the scheduler, a transaction release message to the channel manager to authorize execution of the next transaction.

In Example 9, the subject matter of Example 8 includes, wherein the operations further comprise: calculating, by the channel manager, a predicted completion time of the first transaction based on historical transaction data.

In Example 10, the subject matter of Example 9 includes, wherein the operations further comprise: sending, by the channel manager, the speculative transaction complete indication to the scheduler a specified time prior to the predicted completion time.

In Example 11, the subject matter of Example 10 includes, wherein the operation of sending, by the channel manager, the speculative transaction complete indication further comprises: polling a status of the first transaction at specified intervals after the predicted completion time until the first transaction is complete.

In Example 12, the subject matter of Examples 8-11 includes, wherein the operation of determining the next transaction to pre-stage further comprises: prioritizing, by the scheduler, the next transaction based on a type of operation, including read, write, or erase operations.

In Example 13, the subject matter of Examples 8-12 includes, wherein the system conditions comprise a limit on a number of active channels.

In Example 14, the subject matter of Examples 8-13 includes, wherein the operations further comprise: determining, by the scheduler, whether the system conditions are met to release the next transaction based on factors including the number of concurrent transactions, power consumption limits, and current system load.

Example 15 is a computing device for predictive scheduling of transactions in a multi-channel communication interface, the computing device comprising: a hardware processor; a memory, the memory storing instructions, which when executed by the hardware processor cause the computing device to perform operations comprising: receiving, by a scheduler, a speculative transaction complete indication from a channel manager for a first transaction, the speculative transaction complete indication being sent prior to an actual completion of the first transaction, the channel manager managing a channel of the multi-channel communication interface; responsive to receiving the speculative transaction complete indication: determining, by the scheduler, a next transaction to pre-stage from a list of pending transactions based on predefined criteria; and sending, by the scheduler, the next transaction to the channel manager for pre-staging; subsequent to receiving the speculative transaction complete indication, receiving, by the scheduler, an actual transaction complete message from the channel manager indicating the actual completion of the first transaction; and responsive to receiving the actual transaction complete message: determining, by the scheduler, whether system conditions are met to release the next transaction, the system conditions including power consumption limits; and sending, by the scheduler, a transaction release message to the channel manager to authorize execution of the next transaction.

In Example 16, the subject matter of Example 15 includes, wherein the operations further comprise: calculating, by the channel manager, a predicted completion time of the first transaction based on historical transaction data.

In Example 17, the subject matter of Example 16 includes, wherein the operations further comprise: sending, by the channel manager, the speculative transaction complete indication to the scheduler a specified time prior to the predicted completion time.

In Example 18, the subject matter of Example 17 includes, wherein the operation of sending, by the channel manager, the speculative transaction complete indication further comprises: polling a status of the first transaction at specified intervals after the predicted completion time until the first transaction is complete.

In Example 19, the subject matter of Examples 15-18 includes, wherein the operation of determining the next transaction to pre-stage further comprises: prioritizing, by the scheduler, the next transaction based on a type of operation, including read, write, or erase operations.

In Example 20, the subject matter of Examples 15-19 includes, wherein the system conditions comprise a limit on a number of active channels.

In Example 21, the subject matter of Examples 15-20 includes, wherein the operations further comprise: determining, by the scheduler, whether the system conditions are met to release the next transaction based on factors including the number of concurrent transactions, power consumption limits, and current system load.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for predictive scheduling of transactions in a multi-channel communication interface, the method comprising:
at a system controller, using one or more hardware processors:
receiving, by a scheduler, a speculative transaction complete indication from a channel manager for a first transaction, the speculative transaction complete indication being sent prior to an actual completion of the first transaction, the channel manager managing a channel of the multi-channel communication interface;
responsive to receiving the speculative transaction complete indication:
determining, by the scheduler, a next transaction to pre-stage from a list of pending transactions based on predefined criteria; and
sending, by the scheduler, the next transaction to the channel manager for pre-staging;
subsequent to receiving the speculative transaction complete indication, receiving, by the scheduler, an actual transaction complete message from the channel manager indicating the actual completion of the first transaction; and
responsive to receiving the actual transaction complete message:
determining, by the scheduler, whether system conditions are met to release the next transaction, the system conditions including power consumption limits; and
sending, by the scheduler, a transaction release message to the channel manager to authorize execution of the next transaction.

2. The method of claim 1, further comprising calculating, by the channel manager, a predicted completion time of the first transaction based on historical transaction data.

3. The method of claim 2, further comprising sending, by the channel manager, the speculative transaction complete indication to the scheduler a specified time prior to the predicted completion time.

4. The method of claim 3, further comprising, by the channel manager, polling a status of the first transaction at specified intervals after the predicted completion time until the first transaction is complete.

5. The method of claim 1, wherein determining the next transaction to pre-stage comprises prioritizing, by the scheduler, the next transaction based on a type of operation, including read, write, or erase operations.

6. The method of claim 1, wherein the system conditions comprise a limit on a number of active channels.

7. The method of claim 1, further comprising determining, by the scheduler, whether the system conditions are met to release the next transaction based on factors including the number of concurrent transactions, power consumption limits, and current system load.

8. A non-transitory machine-readable medium, storing instructions for predictive scheduling of transactions in a multi-channel communication interface, the instructions, which when executed, cause a machine to perform operations comprising:
receiving, by a scheduler, a speculative transaction complete indication from a channel manager for a first transaction, the speculative transaction complete indication being sent prior to an actual completion of the first transaction, the channel manager managing a channel of the multi-channel communication interface;
responsive to receiving the speculative transaction complete indication:
determining, by the scheduler, a next transaction to pre-stage from a list of pending transactions based on predefined criteria; and
sending, by the scheduler, the next transaction to the channel manager for pre-staging;
subsequent to receiving the speculative transaction complete indication, receiving, by the scheduler, an actual transaction complete message from the channel manager indicating the actual completion of the first transaction; and
responsive to receiving the actual transaction complete message:
determining, by the scheduler, whether system conditions are met to release the next transaction, the system conditions including power consumption limits; and
sending, by the scheduler, a transaction release message to the channel manager to authorize execution of the next transaction.

9. The non-transitory machine-readable medium of claim 8, wherein the operations further comprise: calculating, by the channel manager, a predicted completion time of the first transaction based on historical transaction data.

10. The non-transitory machine-readable medium of claim 9, wherein the operations further comprise: sending, by the channel manager, the speculative transaction complete indication to the scheduler a specified time prior to the predicted completion time.

11. The non-transitory machine-readable medium of claim 10, wherein the operation of sending, by the channel manager, the speculative transaction complete indication further comprises: polling a status of the first transaction at specified intervals after the predicted completion time until the first transaction is complete.

12. The non-transitory machine-readable medium of claim 8, wherein the operation of determining the next transaction to pre-stage further comprises: prioritizing, by the scheduler, the next transaction based on a type of operation, including read, write, or erase operations.

13. The non-transitory machine-readable medium of claim 8, wherein the system conditions comprise a limit on a number of active channels.

14. The non-transitory machine-readable medium of claim 8, wherein the operations further comprise: determining, by the scheduler, whether the system conditions are met to release the next transaction based on factors including the number of concurrent transactions, power consumption limits, and current system load.

15. A computing device for predictive scheduling of transactions in a multi-channel communication interface, the computing device comprising:
a hardware processor;
a memory, the memory storing instructions, which when executed by the hardware processor cause the computing device to perform operations comprising:
receiving, by a scheduler, a speculative transaction complete indication from a channel manager for a first transaction, the speculative transaction complete indication being sent prior to an actual completion of the first transaction, the channel manager managing a channel of the multi-channel communication interface;
responsive to receiving the speculative transaction complete indication:
determining, by the scheduler, a next transaction to pre-stage from a list of pending transactions based on predefined criteria; and
sending, by the scheduler, the next transaction to the channel manager for pre-staging;
subsequent to receiving the speculative transaction complete indication, receiving, by the scheduler, an actual transaction complete message from the channel manager indicating the actual completion of the first transaction; and
responsive to receiving the actual transaction complete message:
determining, by the scheduler, whether system conditions are met to release the next transaction, the system conditions including power consumption limits; and sending, by the scheduler, a transaction release message to the channel manager to authorize execution of the next transaction.

16. The computing device of claim 15, wherein the operations further comprise: calculating, by the channel manager, a predicted completion time of the first transaction based on historical transaction data.

17. The computing device of claim 16, wherein the operations further comprise: sending, by the channel manager, the speculative transaction complete indication to the scheduler a specified time prior to the predicted completion time.

18. The computing device of claim 17, wherein the operation of sending, by the channel manager, the speculative transaction complete indication further comprises: polling a status of the first transaction at specified intervals after the predicted completion time until the first transaction is complete.

19. The computing device of claim 15, wherein the operation of determining the next transaction to pre-stage further comprises: prioritizing, by the scheduler, the next transaction based on a type of operation, including read, write, or erase operations.

20. The computing device of claim 15, wherein the system conditions comprise a limit on a number of active channels.

21. The computing device of claim 15, wherein the operations further comprise: determining, by the scheduler, whether the system conditions are met to release the next transaction based on factors including the number of concurrent transactions, power consumption limits, and current system load.
